(19) United States
(12) Patent Application Publication
(10) Pub. No.: US 2017/0268445 A1
(43) Pub. Date: Sep. 21, 2017

(54) INTERNAL COMBUSTION ENGINE

(71) Applicant: SICK Engineering GmbH, Ottendorf-Okrilla (DE)

(72) Inventor: Kai KLINDER, Ottendorf-Okrilla (DE)

(21) Appl. No.: 15/461,522

(22) Filed: Mar. 17, 2017

(30) Foreign Application Priority Data
Mar. 18, 2016 (DE) 102016105095.4

(51) Int. Cl. F02D 41/02; G01N 15/06; F02D 41/30; F01N 3/021; F02D 41/00

(52) U.S. Cl. CPC F02D 41/0235; F01N 3/021; F02D 41/0047; F02D 41/0002; F02D 41/3005; G01N 15/06; F01N 2430/00; F01N 2900/1402; F01N 13/10

(57) ABSTRACT

To enable an improved operating behavior of an internal combustion engine, an internal combustion engine having at least one combustion chamber, having at least one air inlet section for the supply of air into the combustion chamber, having at least one exhaust gas outlet for the discharge of exhaust gas into at least one exhaust gas tube, having at least one optical particulate measurement sensor, and having a control apparatus for controlling an operating behavior of the internal combustion engine is provided, wherein the optical particulate measurement sensor is provided to determine a particulate concentration in the exhaust gas and to make available at least one particulate concentration signal for the control apparatus derived from the particulate concentration and wherein the control apparatus is configured to directly change the operating behavior of the internal combustion engine based on the particulate concentration signal of the optical particulate measurement sensor.

The invention relates to an internal combustion engine having at least one combustion chamber, having at least one air inlet section for the supply of air into the combustion chamber, having at least one exhaust gas outlet for the discharge of exhaust gas into at least one exhaust gas tube, having at least one optical particulate measurement sensor, and having at least one control apparatus for controlling an operating behavior of the internal combustion engine and to a method of controlling an internal combustion engine.

Modern internal combustion engines are developed with the aim of working with an ideal power at a minimum fuel consumption. In this respect the internal combustion engines must maintain predefined emission boundary values.

In order to achieve this, highly complex engine controls, in particular a so-called engine exhaust gas management system is provided that can reduce the fuel consumption for increased engine power, in that the engine control controls a supply of combustion air and a supply of fuel in such a way that an ideal combustion is present.

For this purpose diverse parameters are determined on the operation of the internal combustion engine and during the development of an engine by means of various sensors in order to derive an engine operating characteristic field from the parameters with reference to which the engine control regulates the operation of the internal combustion engine. The parameters can, for example, represent an angular position of the gas pedal, an operating temperature, a residual oxygen content in the exhaust gas, a fuel-to-air ratio, a pressure difference between the engine inlet side and the engine outlet side or the like.

The derived engine operating characteristic field is stored in the engine control in such a way that a comparison of actual operating data of the internal combustion engines to the engine operating characteristic field are carried out with reference to the measured sensor signals during the driving operation, in order to generate corresponding control signals that enable an optimized operation of the internal combustion engine by means of a regulating members, such as, amongst others, a turbocharger or fuel injection, exhaust gas resupply flap.

In other words the sensor signals enable a determination of the ideal engine operating characteristic from the stored engine operating characteristic field in such a way that the suitable control signals can be derived from the engine operating characteristic on the basis of which the internal combustion engine can be operated in an ideal range.

From the DE 101 24 235 B4 a theoretical method in the laboratory frame is known that determines the kind, the composition and/or the concentration of the components of engine exhaust gases and the exhaust gas tract after the internal combustion engine, wherein Raman scattering generated in a region to be investigated is detected and used for the determination. This means that the exhaust gases are essentially analyzed by means of optical spectroscopy methods demanding in effort and cost in order to obtain measurement information with which the above described operation of the internal combustion engine can be carried out.

Such a described engine control is highly complex respectively expensive and cannot react fast enough or not at all to short term effects, such as for example, instabilities of the combustion, changing fuel compositions, nor to long term effects, such as for example, part wear or chemical aging.

For this reason it is an object of the invention to make available an internal combustion engine that can compensate a non-ideal operating state in a fast manner.

This object is satisfied in accordance with the invention by an internal combustion engine having at least one combustion chamber, having at least one air inlet section for the supply of air into the combustion chamber, having at least one exhaust gas outlet for the discharge of exhaust gas into at least one exhaust gas tube, having at least one optical particulate measurement sensor, and having a control apparatus for controlling an operating behavior of the internal combustion engine, wherein the optical particulate measurement sensor is provided for determining a particulate concentration in the exhaust gas and for making available at least one particulate concentration signal for the control apparatus derived from the particulate concentration, and wherein the control apparatus is configured to directly change the operating behavior of the internal combustion engine based on the particulate concentration signal of the optical particulate measurement sensor.

In this way the operating behavior of the internal combustion engine can be influenced directly and in real time in accordance with the particulate concentration signal of the particulate measurement sensor by means of the control apparatus without a comparison to an engine operating characteristic field. Hereby the advantage results that the particulate concentration signal of the particulate measurement sensor is transformed directly into the control signal for controlling the internal combustion engine and no determination of the control signal with reference to the engine operating characteristic being required that is both demanding in time and complex. In this connection real time is to be understood in the concept of the present invention such that the use of the transformed particulate concentration signal for the control of the operating behavior of the internal combustion engine has no pronounced delay on the operation of the internal combustion engine as a consequence.

In accordance with a preferred embodiment, the optical particulate measurement sensor is arranged directly at the exhaust gas outlet or at the exhaust gas tube, preferably at an exhaust gas manifold directly after the combustion chamber and/or in front of the exhaust gas filter system.

In accordance with a further embodiment, the optical particulate measurement sensor determines the particulate concentration on the basis of a particulate density measurement value in combination with a through-flow measurement value.

Furthermore, in accordance with a preferred embodiment, in accordance with the particulate concentration signal of the optical particulate measurement sensor, the control apparatus is configured to reduce an amount of a returned exhaust gas for a particulate concentration lying above a normalized value or to increase the amount of the returned exhaust gas for a particulate concentration lying below the normalized value. From this the advantage results that an ideal combustion in the combustion chambers of the internal combustion engine can be achieved in such a way that the internal combustion engine can be operated with an ideal power.

In accordance with a further preferred embodiment, the control apparatus is configured to reduce or to increase a feed volume in the air inlet section in accordance with the particulate concentration signal of the optical particulate measurement sensor.

In accordance with a further preferred embodiment, the control apparatus is configured to directly change a supply of the fuel in accordance with the particulate concentration signal of the particulate measurement sensor.

Furthermore, in accordance with a preferred embodiment, in accordance with the particulate concentration signal of the optical particulate measurement sensor, the control apparatus is configured to directly change the return of the exhaust gas and/or the feed volume in the air inlet section and/or the supply of the fuel. Hereby the advantage results that the engine control receives regulation input parameters in a fast way in order to operate the internal combustion engine in real time in an ideal combustion region.

By means of the combustion optimized by the parameter particulate density, the internal combustion engine utilizes the fuel better. As a consequence thereof less particulates arise that can lead to a blockage of an exhaust gas particulate filter. Thereby a pressure loss in the exhaust gas system remains lower and a maximum power of the internal combustion engine remains available for longer. Moreover, an operating duration of the exhaust particulate filter is increased.

In accordance with a further preferred embodiment, the optical particulate measurement sensor is a scattering light sensor that is cost-effective in such a way that advantageously the complete system can be produced in a cost-effective manner.

It is furthermore an object of the invention to improve a method of controlling an internal combustion engine in such a way that a non-ideal operating state can be compensated faster.

This object is satisfied in accordance with the invention by way of a method of controlling an internal combustion engine having the steps of: determining a particulate concentration in the exhaust gas by means of an optical particulate measurement sensor, making available the at least one particulate concentration signal derived from the particulate concentration for a control apparatus, and directly changing an operating behavior of the internal combustion engine based on the particulate concentration signal of the particulate measurement sensor.

Preferred embodiments and further developments, as well as further advantages of the invention can be found in the subordinate claims, the following description and the drawing.

In the following the invention will be explained in detail with reference to embodiments on the basis of the drawing. The drawing shows:

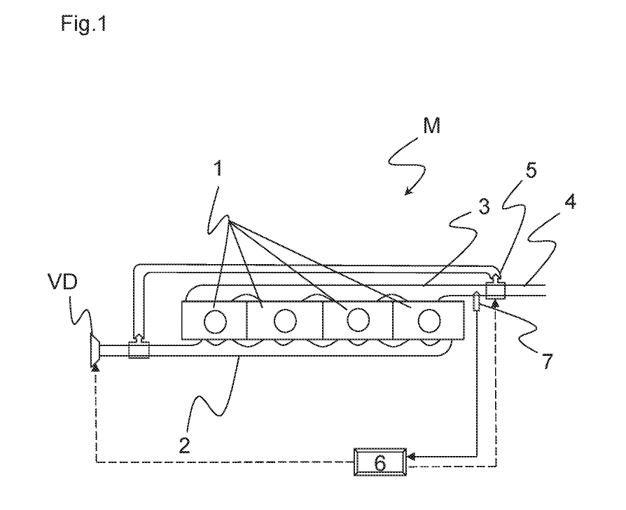

FIG. 1 a schematic illustration of a preferred embodiment of an internal combustion engine in accordance with the invention.

In the FIG. 1 a schematic illustration of a preferred embodiment of an internal combustion engine M in accordance with the invention is shown that in the illustrated embodiment comprises four combustion chambers 1 more specifically four cylinders. At an inlet side of the combustion engine M an air inlet section 2 is provided that is connected to the combustion chambers 1 and serves for the supply of air into the combustion chambers 1.

Preferably at least one air compressor VD is provided at the air inlet section 2 in such a way that the sucked in air can be compressed for an improved combustion. Preferably vanes of the air compressor VD can be adjusted in order to enable the adaptation of a feed amount, of a flow of an amount of air and of an air pre-pressure in the engine control respectively of a control apparatus 6.

At an outlet side of the internal combustion engine M an exhaust gas outlet 3 is provided that is connected to the combustion chambers 1 and serves for the discharge of exhaust gas from the combustion chambers 1 into at least one exhaust gas tube 4. A non-illustrated exhaust gas post-treatment system is provided in the exhaust gas tube 4 that, for example, comprises catalytic converters, in particular so-called diesel oxidation catalytic converters (DOC catalytic converters) or selective catalytic reduction catalytic converters (SCR catalytic converters) or particulate filters. Additionally an exhaust gas return 5 is connected to the air inlet section 2. The exhaust gas outlet 3 in the sense of the invention comprises a manifold and a section between the manifold and the exhaust gas tube 4 that is arranged in front of the exhaust gas return 5.

The internal combustion engine M is controlled in its operating behavior by means of the control apparatus 6. For this purpose the control apparatus 6 receives state measurement data of the internal combustion engine M from different sensors, such as for example, pressure sensors or temperature sensors, in such a way that the control apparatus 6 can control an ideal operating behavior of the internal combustion engine M on the basis of stored characteristics of amounts of air fuel supplied into the combustion chambers 1 or ignition times in the combustion chambers 1.

In accordance with the invention at least one optical particulate measurement sensor 7 is provided that determines a particulate concentration in the exhaust gas. In this connection a portion of non-combusted air fuel mixture in the exhaust gas and in particular incomplete combusted components of the air fuel mixture in the exhaust gas, generally referred to as carbon black, are understood as the particulate concentration in accordance with the invention.

The optical particulate measurement sensor 7 makes available at least one particulate concentration signal for the control apparatus 6 that is derived from the measured particulate concentration in the exhaust gas. This means a control apparatus 6 directly derives control signals from the particulate concentration signal of the optical particulate measurement sensor 7 in order to directly and in real time change the operating behavior of the internal combustion engine M in such a way that the particulate concentration is reduced to approximately zero.

In other words, if the optical particulate measurement sensor 7 determines a very small number of particulates in the exhaust gas that lies beneath a threshold and/or a threshold value, then the control apparatus receives a particulate concentration signal that represents an ideal combustion in such a way that no change is required in the operating behavior of the internal combustion engine M.

If the optical particulate measurement sensor 7 determines a high number of particulates in the exhaust gas, then the control apparatus 6 receives a particulate concentration signal that represents an incomplete combustion in such a way that the control apparatus 6 increases an oxygen supply at the air inlet section 2 by means of the air compressor VD based on the particulate concentration signal and the exhaust gas return 5 in order to reduce an exhaust gas return rate in such a way that the combustion is optimized and the particulate development is reduced in the combustion chambers 1.

If the optical particulate measurement sensor 7 determines too high a gradient of initially a few particulates leading thereafter to many particulates, this means to a too fast increase of particulates in the exhaust gas, then the control apparatus 6 receives a particulate concentration signal that represents a too fast varying incomplete combustion in such a way that the control apparatus 6, for example, controls a non-illustrated fuel injection system with reference to the particulate concentration signal, in order to induce a fast reduction of an injection pressure of the fuel and to increase a pressure of the air compressor VD in order to increase the oxygen supply at the air inlet section 2.

Furthermore, the control apparatus 6 controls the exhaust gas return 5 on the basis of the particulate concentration signal in order to reduce the exhaust gas return rate. Due to the coordinated measures based on the particulate concentration signal of the optical particulate measurement sensor 7, the incomplete combustion in the internal combustion engine M is compensated towards an ideal combustion and the generation of particulates is significantly reduced.

If the optical particulate measurement sensor 7 determines too high a gradient of many particulates to too few particulates, this means a too fast reduction of the number of particulates in the exhaust gas, then the control apparatus 6 receives a particulate concentration signal that represents a too fast varying complete combustion leading to a too lean mixture possibly with too high an oxygen excess in such a way that the control apparatus 6, for example, induces a reduction of the pressure of the air compressor VD with reference to the particulate concentration signal and controls the exhaust gas return 5 in order to increase the exhaust gas return rate. Thereby the ideal power of the internal combustion engine M can be regulated for a minimized fuel consumption.

Hereby the consumption of fuel and of exhaust gas cleaning materials, for example urea solutions, so-called AdBlue, can be reduced and the lifetime of the exhaust gas cleaning system can be increased. Additionally the control apparatus 6 is in a position to change the operating behavior of the internal combustion engine M fast with reference to the particulate concentration signal based on the particulate concentration in the exhaust gas in such a way that short term effects, such as, instability of the combustion and also long term effects, such as, part wear or chemical aging can be compensated in an improved manner.

Advantageously the optical particulate measurement sensor 7 is arranged at the exhaust gas tube 4. Preferably, the optical particulate measurement sensor 7 is arranged directly at the manifold after the combustion chambers 1, wherein the optical particulate measurement sensor 7 or a further optical particulate measurement sensor 7 can be provided in front of an exhaust gas filter system.

Hereby the optical particulate measurement sensor 7 determines the particulate concentration of the exhaust gas on the basis of an extremely fast measurement method, with the optical particulate measurement sensor 7 in particular being a scattering light sensor. This means that a real time analysis of the particulate concentration in the exhaust gas by way of the optical particulate measurement sensor 7 enables the control apparatus 6 to bring about an improved operating behavior of the internal combustion engine M in a fast way. A comparison of the current operating data of the internal combustion engine M with a characteristic field for the purpose of the optimization of combustion is thus omitted.

### LIST OF REFERENCE NUMERALS

1 combustion chamber

2 air inlet section

3 exhaust gas outlet

4 exhaust gas tube

5 exhaust gas return

6 control apparatus

7 particulate measurement sensor

M internal combustion engine

VD air compressor

1. An internal combustion engine, the internal combustion engine
having at least one combustion chamber,
having at least one air inlet section for the supply of air into a combustion chamber,
having at least one exhaust outlet or discharging exhaust gas into at least one exhaust gas tube,
having at least one optical particulate measurement sensor, and
having a control apparatus for controlling an operating behavior of the internal combustion engine,
wherein the optical particulate measurement sensor is provided for determining a particulate concentration in the exhaust gas and for making available at least one particulate concentration signal for the control apparatus, with the at least one particulate concentration signal being derived from the particulate concentration; and
wherein the control apparatus is configured to directly change the operating behavior of the internal combustion engine based on the particulate concentration signal of the optical particulate measurement sensor.

2. The internal combustion engine in accordance with claim 1, wherein the optical particulate measurement sensor is arranged at the exhaust gas outlet or at the exhaust gas tube.

3. The internal combustion engine in accordance with claim 2, wherein the optical particulate measurement sensor is arranged at an exhaust gas manifold directly after the internal combustion chamber and/or in front of an exhaust gas filter system.

4. The internal combustion engine in accordance with claim 1, wherein the optical particulate measurement sensor is configured to determine the particulate concentration on the basis of a particulate density measurement value in combination with a through-flow measurement value.

5. The internal combustion engine in accordance with claim 1, wherein, in accordance with the particulate concentration signal of the optical particulate measurement sensor, the control apparatus is configured to reduce an amount of a returned exhaust gas for a particulate concentration lying above a normalized value or to increase an amount of the returned exhaust gas on a particulate concentration lying below the normalized value.

6. The internal combustion engine in accordance with claim 1, wherein the control apparatus is configured to reduce or to increase a feed volume of the air in the air inlet section in accordance with the particulate concentration signal of the optical particulate measurement sensor.

7. The internal combustion engine in accordance with claim 1, wherein the control apparatus is configured to directly change a supply of a fuel in accordance with the particulate concentration signal of the particulate measurement sensor.

8. The internal combustion engine (M) in accordance with claim 5, wherein the control apparatus is configured to reduce or to increase a feed volume of the air in the air inlet section in accordance with the particulate concentration signal of the optical particulate measurement sensor, wherein the control apparatus is further configured to directly change a supply of a fuel in accordance with the particulate concentration signal of the particulate measurement sensor and wherein, in accordance with the particulate concentration signal of the particulate measurement sensor, the control apparatus is configured to directly change the return of the exhaust gas and/or the feed volume of the air in the air inlet section and/or the supply of the fuel in the sense of an optimized combustion.

9. The internal combustion engine in accordance with claims 1, wherein the optical particulate measurement sensor is a scattered light sensor.

10. The internal combustion engine in accordance with claim 1, wherein the direct change of the operating behavior of the internal combustion engine can be carried out in accordance with the particulate concentration signal of the particulate measurement sensor by way of the control apparatus in real time without a comparison to an engine operating characteristic field.

11. A method of controlling an internal combustion engine, the method comprising the steps of:
determining a particulate concentration in the exhaust gas by means of an optical particulate measurement sensor;
making available at least one particulate concentration signal for a control apparatus, with the at least one particulate concentration signal being derived from the particulate concentration; and
directly changing an operating behavior of the internal combustion engine based on the particulate concentration signal of the particulate measurement sensor.
